(19) United States
(12) Patent Application Publication
(10) Pub. No.: US 2010/0003635 A1
(43) Pub. Date: Jan. 7, 2010

(54) DENTAL IMPLANT

(76) Inventor: Johan Feith, Munchen (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(21) Appl. No.: 11/722,354

(22) PCT Filed: Dec. 21, 2005
(86) PCT No.: PCT/EP05/13805

§ 371 Date: Jun. 21, 2007

(30) Foreign Application Priority Data
Dec. 21, 2004 (DE) 10 2004 061 583.7
Feb. 8, 2005 (DE) 10 2005 005 656.3

(51) Int. Cl. A61C 8/00; A61C 3/02; A61C 13/08

(52) U.S. Cl. 433/75; 433/173; 433/201.1

(57) ABSTRACT

A dental implant is provided having an anchoring part for anchoring the dental implant in the bone and an abutment for fastening a superstructure, the abutment being connected to the anchoring part, and the anchoring part and the abutment being based on zirconium oxide. The anchoring part is provided with at least two substantially cylindrical bodies, the center axes of which extend in the same direction and which are integrally connected to one another at upper ends, so as to form the abutment, and which can be inserted into corresponding holes in the jaw bone.

### CROSS-REFERENCE TO RELATED APPLICATIONS

This application is a Section 371 of International Application No. PCT/EP2005/013805, filed Dec. 21, 2005, which was published in the German language on Jun. 29, 2006, under International Publication No. WO 2006/066898 A3 and the disclosure of which is incorporated herein by reference.

### BACKGROUND OF THE INVENTION

The invention relates to a dental implant and also to a method for manufacturing a dental implant.

A broad range of embodiments of dental implants is known. They are used to receive superstructures, such as bridges, crowns or the like. A dental implant of this type is known, for example, from German published patent application DE 101 59 683, this dental implant being made of zirconium ceramic.

In cases in which several teeth are to be replaced, a plurality of corresponding dental implants is conventionally used. Not only is this expensive, it can also occur that the space available in the jaw bone is no longer suitable, in particular as a result of shrinkage, for example owing to the relatively long existence of gaps, for receiving a plurality of implants of this type. In addition, the stability of an individual implant is no longer sufficient, specifically in problematic bone conditions.

### BRIEF SUMMARY OF THE INVENTION

An object of the invention is to provide a dental implant and also methods for manufacturing and/or positioning the dental implant, a jig and a drive-in aid for inserting a dental implant of this type, which are suitable for ensuring increased strength with simple manufacture and use or processing.

The object is achieved by a dental implant for a patient, comprising an anchoring part for anchoring the dental implant in the bone and an abutment for fastening a superstructure connected to the anchoring part, the anchoring part and the abutment being made of zirconium ceramic, as a result of the fact that the anchoring part comprises at least two substantially cylindrical bodies, the center axes of which extend in the same direction and which are integrally connected to one another at their upper ends so as to form the abutment and which can be inserted into corresponding holes in the jaw bone.

As a result of the fact that the two cylindrical bodies, which are after all rigidly connected to each other, extend in the same direction, the dental implant can be driven into the holes in the jaw. The resilience of this dental implant is substantially greater than the overall strength of individual dental implants, as bending moments are absorbed much more beneficially as a result of the acting levers of the connection between the two cylindrical bodies. This applies to loading in almost all directions and at all points of the chewing surfaces except for the respective individual points located directly on the center axis of the respective cylindrical bodies.

In principle, the dental implant can be used also for reconstructing a single tooth. Preferably, however, two teeth located next to each other or, in particular, three teeth are replaced by the dental implant, the abutment then being configured to form a bridge for three prosthetic elements. This greatly reduces the cost of replacing several teeth.

Preferably, the abutment has a pontic structure between the anchoring parts. This greatly reduces the cost of producing a bridge. In a pontic structure of this type, the portion of the structure located below the connection between the anchoring parts is polished and preferably oviform, so this portion located on or adjoining the gums can at the same time form the lower portion of the superstructure. The zirconium ceramic is preferably also dyed in this case so as to correspond to the superstructure.

A superstructure can be attached (bonded or cemented on) to the dental implant in a manner known per se. In a preferred embodiment of the invention, the superstructure, in particular a bridge, is fastened to the abutment, in particular melted thereon, before the dental implant has even been inserted. Not only can this provide a much more secure connection between the dental implant and superstructure, it is also possible significantly to reduce the number of operations.

In a construction of this embodiment, the superstructure comprises merely a front, labial portion. The abutment therebehind is, in particular, accessible from above and can be introduced or driven into the jaw without loading the superstructure.

Alternatively, the superstructure fastened to the abutment comprises an opening such that the abutment is, in particular, accessible from above. This simplifies insertion of the dental implant or driving into the holes without damaging the superstructure. This advantage can be utilized without affecting the cost or the quality of the work, as non-visible portions (for example, portions remote from the labial side of the tooth) can easily be attached after the positioning of the implant. In addition, the chewing surfaces are generally adapted or produced after insertion of the implant. This can be carried out without additional cost in connection with the sealing of the opening.

Merely partial production of the superstructure fastened to the abutment can be obtained even if relieving or protecting of the newly positioned implant is desired. A provisional part can be attached to the superstructure in such a way that the closing surface of the superstructure is located below the chewing surface of the adjacent teeth and is not loaded during chewing. This provisional part is replaced, after a given healing time of the dental implant, by a final portion which ensures the complete functions. Alternatively, a thin, removable protective rail can be attached to the superstructure and the adjacent teeth, to relieve the dental implant, and removed after a given period of time.

Preferably, the implant has at least one support structure for holding and/or driving the cylindrical bodies into the holes. This allows defined driving-in points to be determined and a support tool to be attached for the purposes of insertion.

The cylindrical bodies preferably have, over a substantial portion of their outer surfaces, a roughened surface which significantly improves the in-growth or the connection to the jaw bone in a manner known per se. This roughened surface is preferably formed before final sintering of a corresponding base element of the dental implant by sandblasting or similar cutting deformation, and this greatly simplifies the manufacture of the dental implant.

The dental implant is preferably provided, at least in the region of the cylindrical bodies, with a protective layer which can be removed immediately before insertion, thus preventing the introduction of germs into the jaw bone. A protective layer of this type can be configured for mechanical removal.

The above-mentioned object is also achieved by a jig for inserting the described dental implant that has at least two holding elements for adjusting the jig on at least one tooth or auxiliary implant rigidly connected to the jaw and also two holes, the center axes of which extend in the same direction, through which a drill can be guided in an adjusted manner for forming the holes in the jaw bone. A jig of this type ensures that the holes for receiving the cylindrical bodies of the dental implant correspond to the implant precisely.

The dental implant can be brought into a secure fitting position in the jaw in a particularly simple manner using a drive-in aid. Preferably, the drive-in aid comprises a body having a receiving opening and a striking plane, the receiving opening being formed to receive at least one portion of the abutment and the striking plane being arranged on the body of the drive-in aid in such a way that the center axis or the center axes of the anchoring part of the abutment inserted into the receiving opening are substantially perpendicular to the striking plane. The drive-in aid could thus be attached to the anchoring part and abutment and provides a point of application by means of which the anchoring part can be driven into the jaw bone. As it can occur that the abutment forms a relatively large angle to the center axes of the anchoring part, the drive-in aid helps to apply forces along the center axes and thus along the driving-in direction. The striking plane provides in this case the required working surface.

Preferably, this drive-in aid is formed from plastic material.

The receiving opening in the drive-in aid does not have completely to surround the abutment. Often, it is sufficient if the upper ends can engage with the receiving opening, thus maintaining a secure fit of the drive-in aid.

Furthermore, the object is achieved by a method for manufacturing a dental implant, in particular a dental implant of the above-described type, including the following steps:

creating a 3-dimensional, digital image of a region of a patient's jaw bone and gums into which the dental implant is to be inserted;

producing a digital representation of the dental implant;

milling a zirconium-based base element, if necessary with excess for compensating for shrinkage;

sandblasting the cylindrical bodies on the base element and

burning/sintering of the machined base element.

The aforementioned jig is also manufactured in accordance with the 3-dimensional, digital image or the digital representation of the dental implant. For this purpose, a corresponding data record and also an impression of the teeth adjacent to the implant are submitted to the dental technician, so both the implant and the jig can be manufactured substantially using digitally controlled machines.

There is preferably provided on a bridge portion of the dental implant a pontic structure between the anchoring parts having an oviform structure so as to form a lower end for a superstructure, this oviform structure being polished before and/or after the burning/sintering, thus reducing labor and leading to an improved end result.

The oviform structure is preferably dyed so as to correspond to the color of the superstructure, and this greatly improves the appearance.

In the preferred embodiment of the invention, after the burning/sintering of the implant, a superstructure is at least partially attached, in particular bonded or melted on, thus producing a dental implant having a ‘semi-finished’ superstructure. It is also possible to provide a complete production of the dental implant, consisting of the abutment having an anchoring part and the attached superstructure. In this case, particular care must be taken during positioning, in particular during hammering-in, of the dental implant to avoid damage to the superstructure. However, tests have also revealed that a finished dental implant provided with a protective sheathing can be inserted if there are corresponding holes in the jaw bone, without damaging the superstructure or another portion of the dental implant. The protective sheathing can, for example, be a detachable plastic material sheathing.

Finally, the invention is achieved by a tool for fastening a dental implant, having at least one cylindrical anchoring part for anchoring in a corresponding hole in a jaw bone, having a hammer head for applying impact loading to the dental implant, in particular to the cylindrical anchoring part, and having a drive means for driving the hammer head over a preadjustable distance, a defined impact loading being pre-adjusted. The doctor inserting the dental implant is therefore no longer solely reliant on his sense of feel with which he drives in the implant. Reproducible working conditions can also be created.

Furthermore, the object is achieved by a method for manufacturing and positioning a dental implant, in particular a dental implant of the above-described type, including the following steps:

generating a 3-dimensional, digital model of the anatomy of the regions adjacent to the future location of the dental implant, in particular of teeth, regions of the jaw bone and the gums;

at least partially computer-assisted designing of the dental implant which can be individually adapted to the anatomy;

producing the dental implant;

validating and documenting the work carried out.

A particular advantage of this method is that the computer-assisted designing of the dental implant individually adapted to the patient's anatomy can be based on the 3-dimensional, digital model of the anatomy, thus allowing optimum, preoperative matching between the dental implant and the patient's anatomy.

The method preferably includes the step of positioning the dental implant.

In this method, one of the other steps required for manufacturing and positioning the implant is preferably carried out using the computer. For example, computer-activating a milling unit, a drill or a nozzle for sandblasting allows the production process to be optimized. Production costs are reduced on account of the savings in terms of staff and lower material wear; accuracy with regard to production errors is increased and the time taken minimized. Operative engagement can also be carried out more efficiently using the computer. A computer equipped with corresponding input and output devices can thus assist the doctor during the operation. As documentation and validation are becoming increasingly important in medical work, storing the implant data and/or the model data and/or various operation and/or production parameters can increase the transparency of the work performed by the dentist and/or dental technician and/or other involved persons. For example, it is possible to compare the actual location of the implant with a planned position or to catalogue and to improve selected operational and/or production parameters with regard to the quality of the work performed (for example, service life of the implant, cosmetic effect, etc.).

To obtain a 3-dimensional, digital model of the anatomy of the regions adjacent to the future location of the dental implant, almost all imaging methods conventional in human medicine such as, for example, CT (computer tomography), MRT (magnetic resonance tomography), medical US (ultrasound), etc. are conceivable. However, use is preferably made of a specific CT method, DVT (digital volume tomography), as the corresponding device for producing the model provides sufficient data, images bones and teeth effectively and precisely and is present in most dental practices.

Software programs (for example, CAD software) for the computer-assisted development of 3-dimensional components have long been known in the industry. Design of individual parts of a dental implant, in particular of the superstructure, abutment and anchoring part, on a computer using a corresponding three-dimensional, digital model of the adjacent anatomy improves the quality of the dental implant. CAD software adapted for the dentist and/or dental technician can be used to design for each patient a dental implant optimally adapted to him and his history. Adaptation of the dental implant after insertion, such as for example fine-tuning of the abutment in the mouth, is dispensed with.

Preferably, the software provides a set of predefined components and/or configurations. There is thus provided for each application (for example, number of teeth to be replaced, position of the implant) a highly suitable crude model of the dental implant requiring just minimal revision for optimum fit. Designing the denture is thus optimally simple for the dentist and/or dental technician.

One possibility for individually adapting the dental implant, comprising the superstructure, abutment and anchoring part, consists in adapting the configuration, in particular the number of prosthetic elements to be received, and/or the diameter of the abutment.

Further adaptable parameters in the production or the design of the dental implant include the height and the shape of the abutment and also the height and shape of the anchoring part.

A further possibility for adapting the dental implant consists in adapting the abutment and the anchoring part in such a way that the angle between the hole axis provided for the anchoring part and the axis of horizontal orientation of the superstructure can be chosen freely.

Preferably, it is possible to adapt the length and/or the diameter and/or the color of the superstructure in the computer-assisted design of the dental implant. The length and diameter of the superstructure are the crucial factors for the functions and service life of the dental implant, the diameter and color determine the appearance of the denture.

If the at least partially computer-assisted designing includes computer-assisted planning of the location of the dental implants, the design can be adapted precisely to the adjacent anatomy. In addition, the positioning of the implant can be planned preoperatively.

Automatically, a drill rail can be generated at the planned position firstly as a 3-dimensional model and subsequently as a real drilling jig for insertion of the dental implant. The drill rail helps the position, the correct drilling angle and the exact planned drilling depth to be found during drilling.

If the computer additionally provides device navigation (i.e. the position of the instruments used can be determined intra-operatively, relative to the position of the patient), the computer can help the doctor, as in a car navigation system, to find the optimum, preoperatively planned target position of the dental implant. The computer could also perform a portion of the intra-operative device activation (for example, rotational speed of the drill) using suitable input and output devices.

The production of the dental implant preferably includes computer-assisted generating of a cap for receiving a superstructure. In the manufacture of fixed dental implants, an impression of the previously fastened dental implant is conventionally produced after the attachment of an artificial root, i.e. once the anchoring part and the abutment have been introduced into the jaw bone. This impression is used to produce a cap which fits precisely to the abutment. This cap forms the carrier for the future superstructure or crown. A powder/liquid mixture is conventionally applied to the cap and burned in a furnace to form a ceramic. The ceramic forms substantially the visible portion of the denture. The pre-produced cap ensures a secure fit of the superstructure, thus avoiding errors normally caused during imprinting in the mouth for producing the cap, for example as a result of saliva, blood, imprecise preparation limits and changes in the dimensions of the impression during transportation from the dentist to the laboratory.

The computer-assisted designing of the dental implant preferably includes the computer-assisted designing of an abutment and the computer-assisted generating of the cap includes computer-assisted calculation of an internal structure of the cap, allowing the cap to be attached to the abutment. In this way, the appropriate cap for subsequently receiving the superstructure can be designed or produced as early as the planning stage or during the designing of the dental implant. As the data concerning the dimensions of the abutment is provided for the design of the dental implant, it is easy to calculate a precisely fitting cap therefor. There is no need to produce an impression.

Even if the cap is not generated in a computer-assisted manner, it is possible to produce it in the dental technician's laboratory, as the individually produced dental implant does not have to be adapted in situ, i.e. in the patient's mouth.

The calculation of the internal structure preferably considers the intake of adhesives for fastening the cap in the abutment. Other variables, such as for example a degree of shrinkage of the material used, can also affect the calculation.

It is advantageous if the computer-assisted generating of the cap includes computer-controlled milling of the cap or of a model of the cap. The computer-produced model of the cap can thus be implemented relatively inexpensively. For this purpose, either the cap can be milled out immediately using a milling unit or there can be produced a model which subsequently forms the basis for the manufacture of the cap. Equally, a casting mould for the cap could also be produced in a computer-assisted manner.

The positioning of the dental implant preferably includes production of a drive-in aid for the dental implant, thus facilitating for the dentist the insertion or driving-in of a dental implant which can be driven in. Crucial in this regard is a secure fit of the drive-in aid to the dental implant, thus preventing both slipping-out of and damage to the dental implant.

If the dental implant comprises an abutment and an anchoring part connected to the abutment for anchoring the dental implant in the jaw bone, it is advantageous if the production of the drive-in aid includes the forming of a receiving opening on the drive-in aid for receiving at least one portion of the abutment. The drive-in aid can thus receive this portion with a precise fit and establish a secure connection to the abutment.

Preferably, the production of the drive-in aid includes computer-assisted calculation of the receiving opening, so the drive-in aid can be attached to the abutment. As the computer-assisted design of the dental implant, preferably also of the abutment, provides precise data with regard to the shape and surface structure of the abutment, it is possible to configure the receiving opening so as to ensure secure attachment of the drive-in aid to the abutment.

Preferably, the production of the drive-in aid includes computer-assisted determining of at least one center axis of the anchoring part and computer-assisted forming of a striking plane on the drive-in aid, the striking plane ideally being perpendicular to the center axis. Determining the center axis of the anchoring part, which is substantially identical to the direction in which the dental implant is driven in, allows the drive-in aid adapted to the dental implant to be configured in such a way that the force applied via the striking plane is transmitted to the dental implant in such a way as to allow simple driving-in thereof.

Preferably, the production of the drive-in aid includes computer-controlled milling of the drive-in aid or of a model of the drive-in aid, thus facilitating the production of the drive-in aid itself or of a model or an impression which subsequently acts as a basis for generating the drive-in aid.

Preferred embodiments of the invention emerge from the sub-claims.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a side view of a first embodiment of a dental implant according to the invention;

FIG. 2 is a view corresponding to FIG. 1 of a second embodiment of a dental implant according to the invention;

FIG. 3 is a partial section through the dental implant according to FIG. 2 along the line III-III from FIG. 2;

FIG. 4 is a side view in partial section of a jig having a plaster model;

FIG. 5 is a schematic view of a fastening tool;

FIG. 6 is a cross section through a third embodiment of a dental implant according to the invention;

FIG. 7 is a schematic view of a drive-in aid according to the invention;

FIG. 8a shows an abutment according to the invention having an anchoring part;

FIG. 8b shows a superstructure for the abutment from FIG. 8a;

FIG. 8c shows a cap for the superstructure from FIG. 8b;

FIG. 9a shows a further abutment according to the invention having an anchoring part;

FIG. 9b shows a superstructure for the abutment from FIG. 9a;

FIG. 9c shows a cap for the superstructure from FIG. 9b;

FIG. 10 is a cross sectional view through a fourth embodiment of a dental implant according to the invention;

FIGS. 11a and 11b show a method according to the invention for producing a superstructure; and

FIG. 12 shows a plurality of dental implants according to the invention in a jaw.

### DETAILED DESCRIPTION OF THE INVENTION

In the following description, the same reference numerals will be used for identical and equivalent parts.

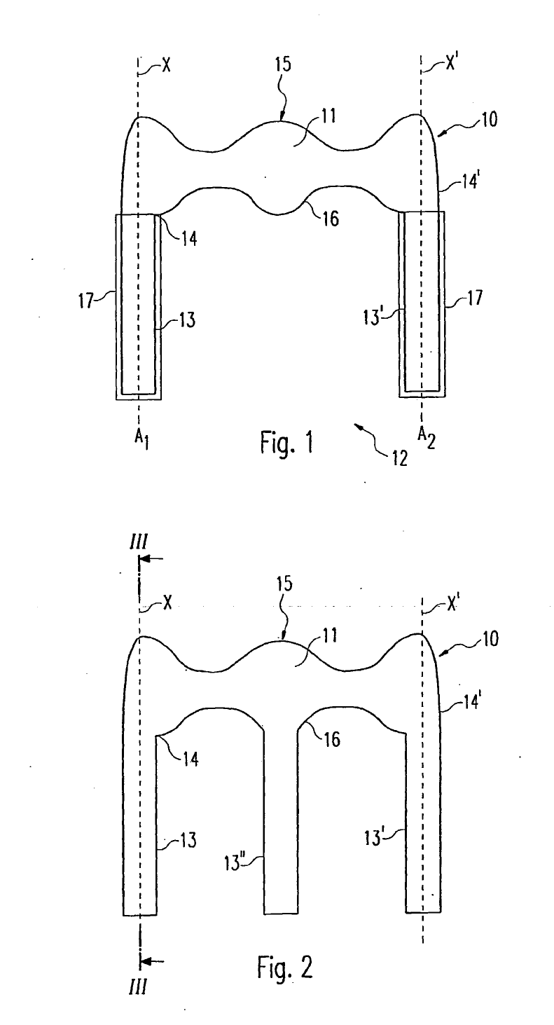

As shown in FIG. 1, the present embodiment of an implant 10 comprises two cylindrical bodies 13, 13′ which form an anchoring part 12 and are inserted (driven in from above) into corresponding cylindrical holes in a jaw bone. These cylindrical bodies 13, 13′ are connected at their upper ends (14, 14′) via an abutment 11, thus forming a one-piece body.

A pontic structure 15 is provided between the two cylindrical bodies 13, 13′, so a bridge can be attached as a superstructure.

The pontic structure 15 can have, at its lower end facing the gums, a polished portion 16 which is no longer covered by a superstructure but rather, visually, is a component thereof.

The implant 10 as a whole is preferably provided in accordance with the color of the final superstructure 20, so transitions between the superstructure 20 and abutment 11 are hardly visually discernible any more.

To produce the implant 10, there is milled out of a zirconium oxide-based blank or base element which can still very easily be machined, in accordance with digital data (the derivation of which will be described hereinafter), a shape corresponding to that according to FIG. 1 and, if necessary, with excess such that after burning/sintering of the base element, to transfer the element into its final, highly resistant fine structure, the final dimensions are achieved.

Furthermore, the anchoring part 12 is roughened at those points intended to grow together with the bone, before the burning/sintering, for example by sandblasting or similar processing procedures known per se. This roughening can be carried out very easily on the base element whereas the fully burnt/sintered product can be machined only with a very high degree of effort.

Once the implant 10 has been manufactured in the described manner, it can be sterilised and packaged to be forwarded to the doctor carrying out the treatment. Advantageously, at least those parts of the implant 10 that are to be inserted into the bone are coated, after the sterilising, with a protective layer 17 which is removed immediately before insertion, for example by mechanical extraction. This ensures the highest degree of sterility.

The embodiment of the invention shown in FIG. 2 differs from that according to FIG. 1 in that the dental implant 10 comprises a further, third, cylindrical body 13″ forming, together with the other two cylindrical bodies 13, 13′, an anchoring part 12. The third cylindrical body 13″ is located centrally between the other two cylindrical bodies 13″ and offers additional stability during positioning of the dental implant 10.

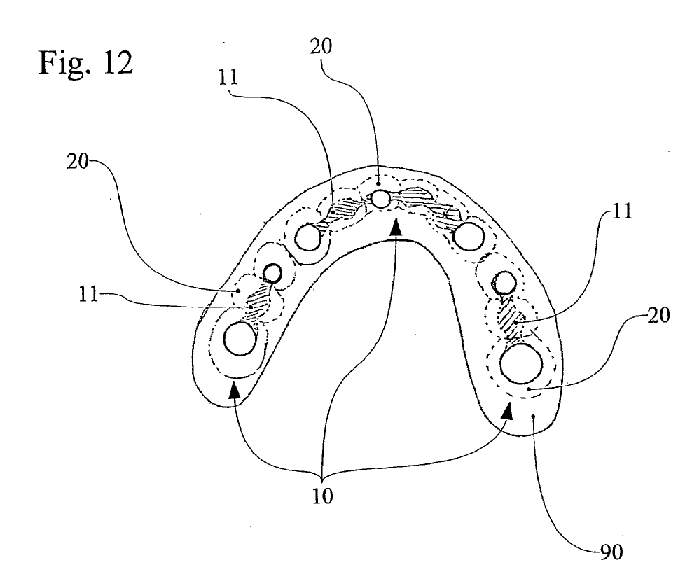

Further embodiments according to the invention of the dental implant which can be driven in may be inferred from FIG. 12. It is thus possible to fasten to an anchoring part having three cylindrical bodies 13, 13′, 13″ a superstructure 20 for four or more crowns. FIG. 12 is a plan view of three dental implants 10 according to the invention which are anchored in a jaw bone 90. The two outer dental implants 10 receive in this case a superstructure 20 having three respective crowns. The abutments 11 of these two dental implants are of similar configuration to the abutment 11 of FIG. 1. The third central dental implant 10 has a superstructure 20 which can receive six schematically indicated crowns. The associated abutment 11 has, in the plan view along the center axes (not shown) of the anchoring part, a curved, slightly U-shaped form based on the arrangement of the front incisors. It is clear from the exemplary total prosthesis, as shown in FIG. 12, that there are a large number of possibilities for the configuration according to the invention of the dental implant 10 which can be driven in.

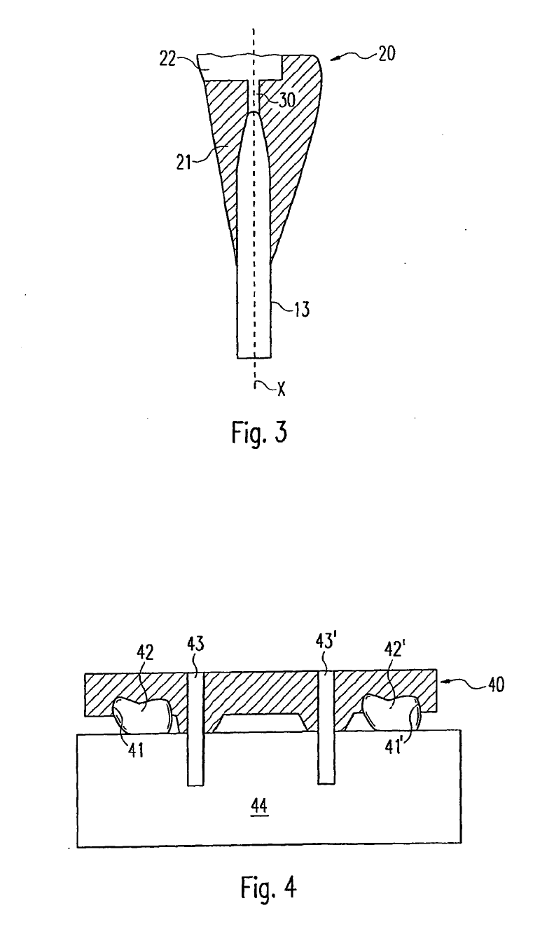

FIG. 3 is a cross section of the implant 10 shown in FIG. 2, but with an attached superstructure 20. The superstructure is, in the present embodiment, of two-part configuration such that a fixed portion 21, surrounding the abutment 11, of the superstructure 20, the labial portion of which is fully configured, has finally been melted onto the abutment 11; the remaining part of the superstructure 20 is in the form of a provisional portion 22. The provisional portion 22 is fastened to the dental implant 10 only once the implant has been positioned. There thus remains during positioning of the dental implant 10 an opening 30, via which the force can be exerted onto the abutment 11 without damaging the superstructure 20. This, and the fact that the dental implant can be held via a driving-in pin (not shown) located in the opening 30, facilitates insertion, in particular hammering-in, and protects the superstructure 20. In general, the opening 30 can therefore be used not only as an access to the abutment 11 but also as a support for improved insertion of the implant.

It is possible to make the provisional portion 22 lower (or to grind it down), thus substantially reducing the forces (caused, for example, by the gnashing of teeth or chewing) acting on the new implant during the healing phase.

Alternatively, a fully produced superstructure can also be attached, prior to insertion, to the abutment 11 which is then inserted into the jaw as a component. To protect the dental implant during driving-in thereof, it can be provided with a protective cap.

A further alternative for insertion of the abutment 11 having the anchoring part 12 is shown in FIG. 7. The superstructure is in this case preferably not attached, or is attached merely to a low degree, prior to insertion into the jaw. Insertion is assisted by a drive-in aid 70 produced individually for each dental implant. This drive-in aid 70 is configured so as to form an adapter between the abutment 11 and a striking tool (see the schematically illustrated hammer of FIG. 7). The important thing for the functions of the striking aid is that the forces applied thereto are forwarded to the abutment 11 and the anchoring part 12 so as to act precisely parallel to the center axes X, X′ (see also FIGS. 1 and 2) of the anchoring part 12. For this purpose, the drive-in aid 70 comprises a body 71, out of which a receiving opening 73 is milled in such a way that the respective abutment 11 is located securely in this receiving opening 73. Located on the side of the body 71 that is remote from the receiving opening 73 is a striking plane 72 formed on the body 71 substantially so as to provide a surface at right angles to the center axes X, X′. The drive-in aid is especially advantageous in the embodiment of an abutment 11 according to the invention shown in FIG. 7, as in this embodiment the abutment axis Y is not parallel to the center axes X, X′, so the application of drive-in forces toward the center axes X, X′ onto the markedly inclined abutment 11 is difficult.

In order to define the shape of the implant, there is initially obtained in a manner known per se using a CT/DVT method a data record for deriving the jaw structure at least in the region in which the implant is to be inserted. Software processes known per se are used further to define a basic shape of the implant which is then virtually inserted into the bone. Varying the shape of the implant, in particular of the cylindrical bodies 13, 13′, and corresponding positioning can in this way allow optimization, in particular with regard to the strength of the jaw bone. Obviously, the structure and position of the adjacent teeth and also of the gums also play an important part in the shaping of the implant, in particular of the abutment.

There is also produced an impression of the teeth next to the region of the implant to be inserted, the basic structure of which is shown in FIG. 4, so as to allow a jig 40 to be produced therefrom. This impression is also used to obtain a plaster model 44 having teeth models 42, 42′ which are inserted therein and are a precise replica of the corresponding teeth of the patient. The jig 40 thus has holding elements 41, 41′ formed as recesses which fit precisely via the teeth adjacent to the implant. The position of the jig 40 relative to the patient's jaw structure is thus defined.

In a subsequent step, holes 43, 43′ are formed in the jig 40 based on the digitised data so as to correspond to the cylindrical bodies 13, 13′. As the jig 40 is defined in its position relative to the jaw, so too are now the holes 43, 43′. The holes 43, 43′ are equipped in a manner known per se with sleeves, so pre-drilling and customized drilling-out are possible.

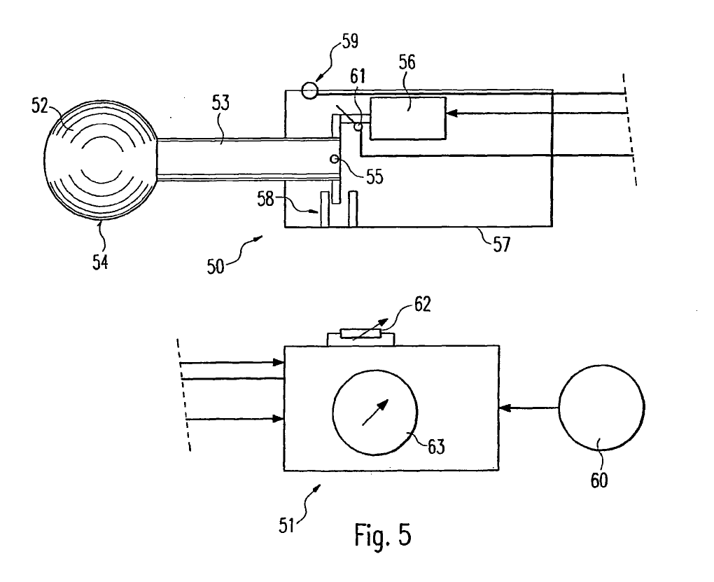

A manually actuatable tool can be used for driving in the implant. However, owing to the extremely limited spatial conditions, use is advantageously made of a tool actuated by an external power supply. A tool of this type will be described hereinafter with reference to FIG. 5.

The tool 50 has a hammer head 52 having, at least in the portion with which the implant 10 is driven in, a substantially spherical or spherical/dome-shaped striking face 54. It has surprisingly been found that a curved surface of this type allows extremely precise work. Obviously, it is also possible to design the striking face 54 so as not to be precisely spherical, for example so as to have parabloidal curvature. The hammer head 52 is fastened to the end of a stem 53 mounted in a handle 57 so as to be rotatable about an axis of rotation 55.

For moving the assembly, there is provided a drive 56 configured in the present embodiment as a pneumatic drive. A pulse sensor 61 is provided for measuring the pulse applied by the hammer head 52 to the implant 10.

Also provided in the handle 57 is an adjustment device 58 for adjusting the distance covered by hammer head 52, so the hammer head covers the same distance each time an actuator 59 is actuated.

The power (pressure) for the pneumatic drive 56 is supplied via a controller 51 which supplies pressure from a compressed air source 60. An adjusting member 62 is provided for adjusting the impact loading. A pulse display 63 is provided for displaying the pulse energy.

It should be noted at this point that this tool can also have a different drive or a different suspension determining the movement of the hammer head 57. However, it is important that a reproducible impact loading is used.

A method according to the invention for manufacturing and positioning a dental implant will be described hereinafter. In the chosen embodiment, this dental implant is a dental implant which can be driven into the jaw bone, such as was described in the foregoing description with reference to FIGS. 1 to 3 and 7 respectively. However, the illustrated method is also suitable for producing other dental implants such as, for example, fixed dental implants for screwing into the jaw or even parts of removable prostheses as dentures.

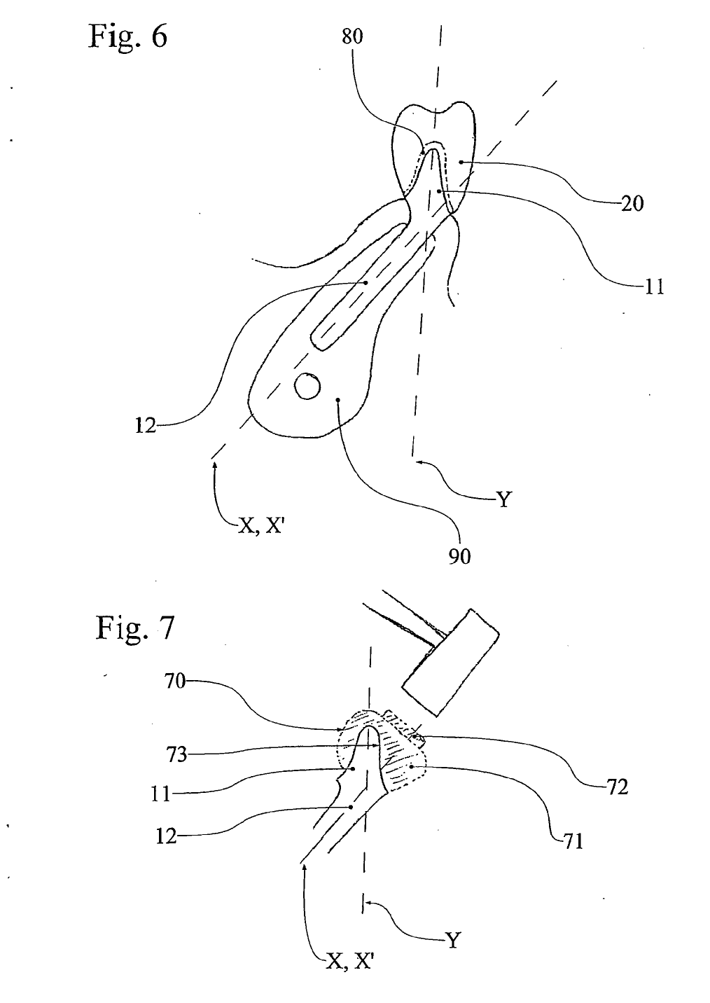

To improve understanding of the method according to the invention, a few important features of a dental implant correctly positioned in a jaw bone will be described with reference to the cross section of FIG. 6. FIG. 6, like FIGS. 1 and 2 before it, shows an anchoring part 12 formed in one piece together with an abutment 11. The superstructure 20 is located on the abutment 11. The anchoring part 12 is driven into the jaw bone 90. For optimum fit of the anchoring part 12 in the jaw bone 90, it is crucial that the center axes X, X′ (see also FIG. 1) of the anatomy of the jaw bone 90 are adapted, i.e. extend in such a way that the anchoring part 12 is located as centrally as possible in the jaw bone substance. On the other hand, an abutment axis Y is crucial to the orientation of the superstructure 20 and thus to the functions and appearance thereof. The abutment axis substantially controls the orientation of the superstructure with regard to the teeth adjacent thereto. For a functional dental implant, it is therefore important that both the center axes X, X′ and the abutment axis Y are chosen so as to be optimally adapted to the respective conditions. As a result of this fact, it can occur, as shown in FIG. 6, that the axes X, X′ and Y do not coincide with one another but rather form an angle relative to one another.

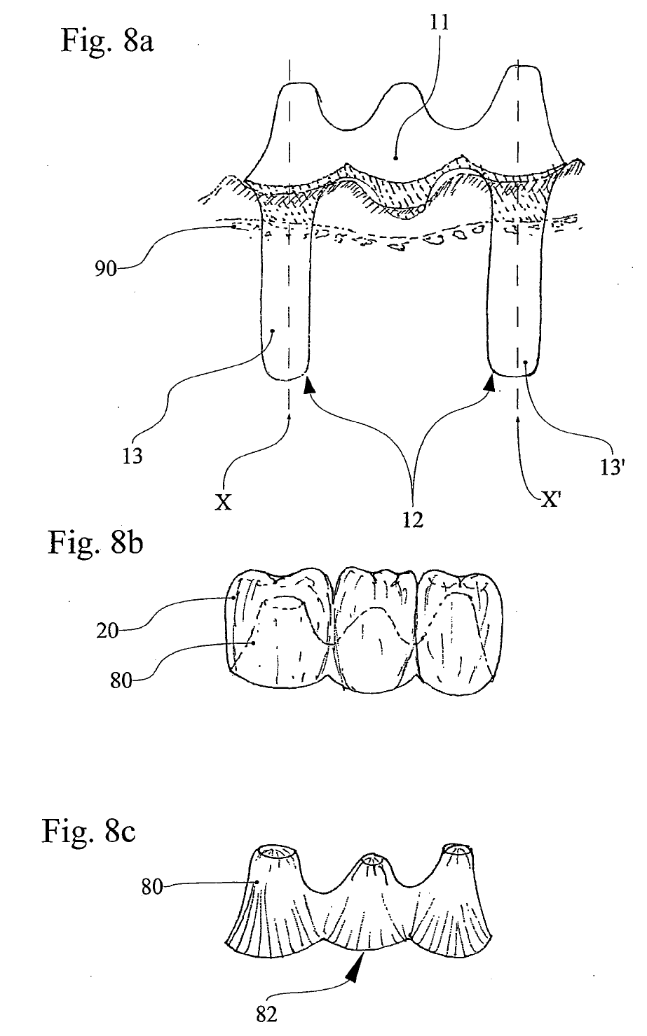

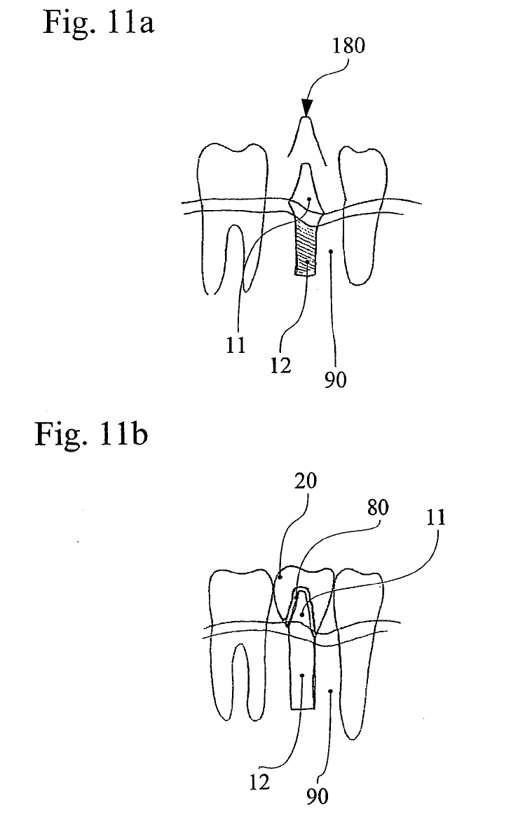

A further important feature of the dental implant from FIG. 6 is a cap 80. Although this cap has only an indirect effect on the functions of the dental implant, it is crucial to the production process. Often, the superstructure 20 is produced separately from the abutment 11 and anchoring part 12. For example, the superstructure 20 is produced in a casting process in which a mould or an impression is filled with a powder/liquid mixture. In order to ensure a secure fit of the superstructure 20 to the abutment 11, the cap 80 is produced in advance in such a way that it fits optimally to the abutment 11 and is then introduced into the powder/liquid mixture which subsequently forms the superstructure. The separate steps of production can be inferred from FIGS. 11a and 11b. FIGS. 8a to 8c further illustrate this fact. FIG. 8a shows a further embodiment of a dental implant according to the invention, similar to that of FIG. 1. The anchoring part 12 comprises a first cylindrical body 13 and a second cylindrical body 13′. The cylindrical bodies are introduced into the jaw bone 90. The abutment 11, shaped integrally with the anchoring part 12, forms a bridge structure between the two cylindrical bodies 13, 13′ which have center axes X, X′ along the longitudinal direction of the cylindrical bodies 13, 13′. There can be attached to the abutment 11 a superstructure 20 (see FIG. 8b) which is conventionally bonded to the abutment 11. To allow the superstructure 20 to be produced so as precisely to fit the abutment 11, the cap 80 forms a part of the superstructure. The important factor for a secure fit of the superstructure 20 or the cap 80 is the cap internal structure 82 (see FIG. 8c) which is based on an inverted structure of an upper portion of the abutment 11.

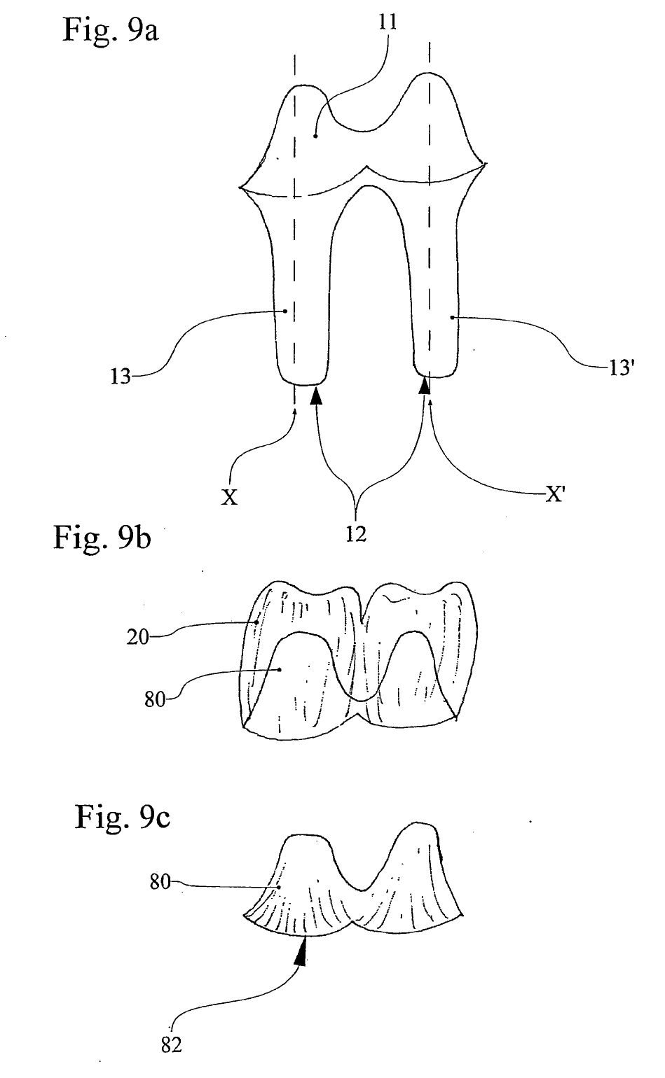

Unlike FIG. 8a, FIG. 9a shows a dental implant or an abutment 11 having an anchoring part 12 with a superstructure 20 which can receive two crowns instead of three crowns. The superstructures 20 and the cap 80 differ accordingly (see FIGS. 9b and 9c).

Turning now to the method according to the invention for manufacturing and positioning a dental implant, this method has five main steps:

generating a three-dimensional digital model of the region adjacent to the future location of the dental implant;

computer-assisted designing of the dental implant individually adapted to the anatomy;

producing the dental implant;

positioning the dental implant;

validating and documenting the work carried out.

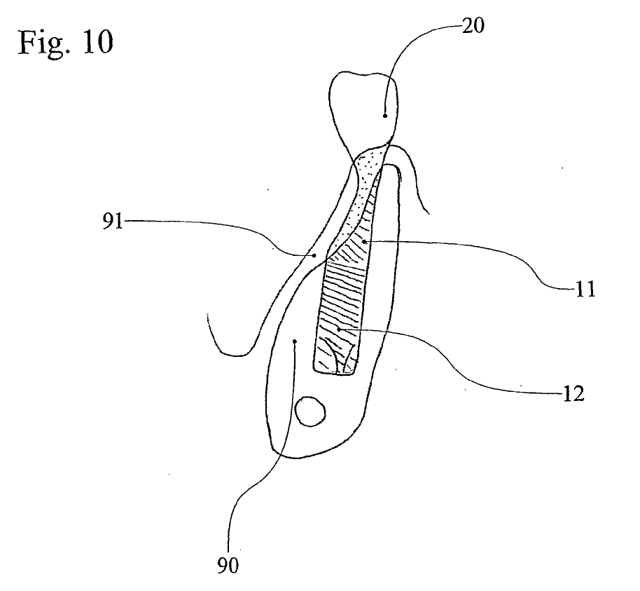

As described hereinbefore, conventional human medicine imaging methods are used to generate the three-dimensional digital model. Examples of such methods include ultrasound, CT, MRT methods and also laser scanning. Software produced specifically for this method can be used to represent the digital model of the most important anatomical structures such as teeth and jaw bones. An individually adapted denture is designed based on this digital model. The software offers various pre-produced components for generating a crude structure of the dental implant. Thus, for example, in a first step, it can be selected whether the denture is intended for a single tooth or several adjacent teeth. There can then be chosen a predefined anchoring part which matches the jaw bone structure as closely as possible and is suitable for carrying the chosen dental implant. The shape of the anchoring part can subsequently be optimally adapted to the respective anatomy, for example using ‘drag and drop’ or by digital inputs. Individual adaptation of the anchoring part is especially helpful if, as a result of osteoporosis or for any other reason, only very little or very one-sided bone substance remains. As shown in FIG. 10, the anchoring part 11 can then be adapted so as to be optimally adapted to the jaw bone 90 and the gums 91. A complex, artificial construction of bone substance can be dispensed with.

A predefined abutment can be selected either simultaneously with the anchoring part or subsequently. The abutment can also be adapted to the individual anatomy by the above-described procedure. Crucial for a secure fit of the dental implant is in this case, in particular, the angle between the center axis X or X′ of the anchoring part 12 and the abutment axis Y (see also FIG. 6).

During the designing of the dental implant, the software simultaneously allows the fitting position of the dental implant in the anatomy to be planned specifically in the jaw bone. The position could also be adapted using ‘drag and drop’ or digital inputs. The software offers a plurality of views suitable for continuously validating the work. As soon as the design and the fit are satisfactory, a functional extension of the software can produce a drill rail which indicates, during subsequent insertion of the dental implant, the positions in the jaw at which pre-drilling is required for the positioning of the dental implant. It would also be conceivable for these positions to be found using computer-assisted device navigation (in this case, of the drill).

Once the location and also the design of the dental implant have been planned, parts of the dental implant can be produced in a computer-assisted manner. A computer-controlled milling unit can thus mill the abutment and anchoring part directly or have produced a model or a shape used for the final production of the components. The superstructure can either be produced directly in a similar manner or modeled onto a cap 80 suitable for the abutment using conventional methods. It is advisable to have the dimensions or shape of the cap calculated in a computer-assisted manner and produced in a computer-controlled manner, for example using a milling unit.

Alternatively, the cap can also be molded in situ onto the finished, individually modeled abutment. In contrast to conventional methods, many of which required the abutment to be adapted in situ, i.e. in the patient's mouth, in the method according to the invention optimum shape of the abutment is available to the dental technician even in the non-inserted state. The dentist no longer requires an impression for producing the cap in the patient's mouth, thus avoiding various errors resulting, for example, from the appearance of blood or saliva or as a result of transportation from the dentist to the dental technician.

Like the cap, a drive-in aid, as described hereinbefore, can also be produced.

The method described hereinbefore therefore allows the highly efficient manufacture of dental implants individually adapted to the anatomy of a respective patient. The high degree of precision in the production process allows the quality of a dental implant of this type to be substantially improved and the service life thereof thus to be substantially lengthened. Some conventional method steps can be dispensed with on account of the reproducibility of the data.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1-41. (canceled)

42. A dental implant for a patient, the implant comprising an anchoring part (12) for anchoring the dental implant (10) in a bone of the patient and an abutment (11) for fastening a superstructure (20) connected to the anchoring part (12), the anchoring part (12) and the abutment (11) comprising zirconium ceramic, wherein the anchoring part (12) comprises at least two substantially cylindrical bodies (13, 13′), the center axes (X, X′) of which extend in the same direction, and which are integrally connected to one another at upper ends (14, 14′) so as to form the abutment (11) and which can be inserted into corresponding holes in the jaw bone (90).

43. The dental implant according to claim 42, wherein the abutment (11) is configured to form a bridge for at least two prosthetic elements.

44. The dental implant according to claim 43, wherein the abutment (11) has, for forming a bridge for at least three prosthetic elements, a pontic structure (15) between the cylindrical bodies (13, 13′).

45. The dental implant according to claim 44, wherein the portion (16) of the pontic structure (15) located below a connection between the cylindrical parts (13, 13′) is polished and oviform.

46. The dental implant according to claim 42, wherein the superstructure (20) is fastened to the abutment (11) before the dental implant (10) is inserted.

47. The dental implant according to claim 46, wherein the superstructure (20) comprises merely a front, labial portion (21), such that the abutment (11) therebehind is accessible from above.

48. The dental implant according to claim 46, wherein the superstructure (20) fastened to the abutment (11) has an opening such that the abutment (11) is accessible from above.

49. The dental implant according to claim 46, wherein the superstructure (20) comprises a provisional portion (22) which protects the dental implant and can be removed after a healing phase or can be replaced by a correspondingly final portion of a superstructure.

50. The dental implant according to claim 42, wherein the anchoring part (12) and the abutment (11) are formed as one part.

51. The dental implant according to claim 42, further comprising at least one support structure (30) for holding and/or driving the cylindrical bodies (13, 13′) into the holes.

52. The dental implant according to claim 42, wherein the cylindrical bodies (13, 13′) have, over a substantial portion of their outer surface, a roughened surface formed by sandblasting or similar cutting deformation before final burning/sintering of a corresponding base element.

53. The dental implant according to claim 42, wherein the dental implant (10) is provided, at least in the region of the cylindrical bodies (13, 13′), with a protective layer (17) which can be removed before the dental implant is positioned and reduces the risk of infection.

54. A drilling jig for inserting a dental implant according to claim 42, comprising at least one holding element (41) for adjusting the jig (40) on at least one tooth and comprising two holes (43, 43′), whose center axes extend in the same direction, through which a drill can be guided in an adjusted manner for forming the holes in the jaw.

55. A drive-in aid (70) for inserting a dental implant according to claim 42, comprising a body (71) having a receiving opening (73) and a striking plane (72), the receiving opening (73) being formed to receive at least one portion of the abutment (11) and the striking plane (72) being arranged on the body (71) of the drive-in aid in such a way that the center axes (X, X′) of the anchoring part (12) of the abutment (11) inserted into the receiving opening (73) are substantially perpendicular to the striking plane (72).

56. The drive-in aid according to claim 55, wherein the body (71) comprises a plastic material.

57. The drive-in aid according to claim 55, wherein the receiving openings (73) are formed for receiving the upper ends (14, 14′).

58. A method for manufacturing a dental implant according to claim 42, including the following steps:
creating a 3-dimensional, digital image of a region of a patient's jaw bone (90) and gums into which the dental implant is to be inserted;
producing a digital representation of the dental implant;
milling a zirconium oxide-based base element optionally with excess for compensating for shrinkage;
sandblasting the cylindrical bodies of the base element;
burning/sintering the machined base element.

59. The method according to claim 58, further comprising providing on a bridge portion of the dental implant a pontic structure between the anchoring parts having an oviform structure for forming a lower edge for a superstructure, wherein the oviform structure is polished before and/or after the burning/sintering.

60. The method according to claim 59, wherein the oviform structure is dyed so as to correspond to a color of the superstructure.

61. The method according to claim 58, wherein after the burning/sintering, a superstructure is melted on.

62. A method for manufacturing and positioning a dental implant according to claim 42, including the following steps:
generating a 3-dimensional, digital model of the anatomy of the regions adjacent to the future location of the dental implant, in particular of teeth, regions of the jaw bone and of the gums;
at least partially computer-assisted designing of the dental implant which is individually adaptable to the anatomy;
producing the dental implant;
validating and documenting the work carried out.

63. The method according to claim 62, further comprising a step of positioning the dental implant.

64. The method according to claim 62, wherein the production and/or the positioning of the dental implant and/or the validating and documenting is carried out in a computer-assisted manner.

65. The method according to claim 62, wherein the digital model is generated based on imaging methods conventional in human medicine optionally DVT.

66. The method according to claim 62, wherein the at least partially computer-assisted designing of the dental implant is carried out using software in which the dental implant is represented digitally using the digital model.

67. The method according to claim 66, wherein the software offers a selection of an amount of predefined components and/or configurations of the dental implant that can be individually adapted.

68. The method according to claim 62, wherein individual adapting of the dental implant, comprising the superstructure (20), abutment (11) and anchoring part (12), includes adapting a configuration of the dental implant, including a number of prosthetic elements to be received, and/or of a diameter and/or a height and/or a shape of the abutment (11) and/or the shape and/or height of the anchoring part (12).

69. The method according to claim 62, wherein individual adapting of the dental implant, comprising the superstructure, abutment (11) and anchoring part (12), includes adapting of the abutment (11) and the anchoring part (12) in such a way that an angle between the hole axis provided for the anchoring part (12) and the axis of horizontal orientation of the superstructure (20) can be chosen freely.

70. The method according to claim 62, wherein individual adapting of the dental implant, comprising the superstructure (20), abutment (11) and anchoring part (12), includes adapting of the length and/or the diameter and/or the color of the superstructure (20).

71. The method according to claim 62, wherein the at least partially computer-assisted designing includes computer-assisted planning of the location of the dental implant.

72. The method according to claim 71, wherein during the computer-assisted planning of the location of the dental implant, a drill rail (40) is generated in a computer-assisted manner for positioning the dental implant.

73. The method according to claim 62, wherein the positioning of the dental implant is facilitated by computer-assisted, intra-operative device navigation and/or computer-assisted, intra-operative device activation.

74. The method according to claim 62, wherein production of the dental implant includes computer-assisted generation of a cap (80) before positioning of the dental implants for receiving a superstructure (20), the cap being generated before the dental implant is positioned.

75. The method according to claim 74, wherein the computer-assisted designing of the dental implant includes computer-assisted designing of an abutment (11) and the computer-assisted generating of the cap (80) includes computer-assisted calculating of an internal structure (82) of the cap (80), so the cap (80) can be attached to the abutment (11).

76. The method according to claim 74, wherein the calculation of the internal structure considers the intake of adhesive for fastening the cap (80) to the abutment (11).

77. The method according to claim 74, wherein the computer-assisted generating of the cap (80) includes computer-controlled milling of the cap (80) or of a model of the cap (80).

78. The method according to claim 62, wherein positioning of the dental implant includes producing a drive-in aid for the dental implant.

79. The method according to claim 77, wherein the dental implant comprises an abutment (11) and an anchoring part (12) connected to the abutment (11) for anchoring the dental implant in the jaw bone (90), production of the drive-in aid (70) including the forming of a receiving opening (73) on the drive-in aid (70) for receiving at least one portion of the abutment (11).

80. The method according to claim 79, wherein production of the drive-in aid (70) includes computer-assisted calculating of the receiving opening (73), so the drive-in aid can be attached to the abutment (11).

81. The method according to claim 78, wherein production of the drive-in aid (70) includes computer-assisted determining of at least one center axis (X, X′) of the anchoring part and computer-assisted forming of a striking plane (72) on the drive-in aid (70), the striking plane (72) being substantially perpendicular to the center axis (X, X′).

82. The method according to claim 78, wherein production of the drive-in aid (70) includes computer-controlled milling of the drive-in aid (70) or of a model of the drive-in aid (70).
